(19) United States
(12) Patent Application Publication
(10) Pub. No.: US 2010/0070697 A1
(43) Pub. Date: Mar. 18, 2010

(54) Memory Controller Circuit, Electronic Apparatus Controller Device and Multifunction Apparatus

(75) Inventor: Takeshi SAITO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/498,987

(22) Filed: Jul. 7, 2009

(30) Foreign Application Priority Data
Sep. 17, 2008 (JP) 2008-237533

(51) Int. Cl. G06F 12/00

(52) U.S. Cl. 711/105; 711/E12.001

(57) ABSTRACT

A memory controller circuit configured to control an SDRAM is provided. The memory controller circuit includes a first unit configured to accept an access request provided by one of a plurality of masters for access to a page included in the SDRAM. The memory controller circuit includes a second unit configured to record an access request period of each of the masters. The memory controller circuit includes a third unit configured to set an open period of the page on the basis of the access request period recorded in the second unit in accordance with the master having provided the access request. The third unit is configured to open the page requested to be accessed for the open period having been set.

### BACKGROUND

1. Technical Field

The present invention relates to a technology for controlling a memory such as an SDRAM.

2. Related Art

It is generally known that a data processing apparatus including an SDRAM controls the SDRAM in such a way as to, in case of continuously accessing the same page, continuously access the page while the page is open without closing the page each time (page mode access).

A technology for controlling a memory in a page mode access has been disclosed, e.g., in JP-A-H09-171484.

In order that a data processing apparatus can further increase processing speed, however, access to a memory needs to be made more efficient.

### SUMMARY

An advantage of some aspects of the invention is that a technology for making access to a memory more efficient by using a simple method is provided.

According to an aspect of the invention, a memory controller circuit configured to control an SDRAM is provided. The memory controller circuit includes a first unit configured to accept an access request provided by one of a plurality of masters for access to a page included in the SDRAM. The memory controller circuit includes a second unit configured to record an access request period of each of the masters. The memory controller circuit includes a third unit configured to set an open period of the page on the basis of the access request period recorded in the second unit in accordance with the master having provided the access request. The third unit is configured to open the page requested to be accessed for the open period having been set.

Moreover, the second unit may be configured to record an access request period of each of the masters addressed to each of the pages, and the third unit, may be configured to set an open period of the page on the basis of the access request period recorded in the second unit in accordance with the master having provided the access request and the page requested to be accessed. The invention includes an electronic apparatus controller device and a multifunction apparatus including the memory controller circuit.

### BRIEF DESCRIPTION OF THE DRAWINGS

The invention will be described with reference to the accompanying drawings, wherein like numbers reference like elements.

FIG. 1 shows an example of a hardware configuration of a printing system of an embodiment of the invention.

FIG. 2 shows an example of a hardware configuration of a memory controller ASIC of the embodiment of the invention.

FIG. 3 is a flowchart showing a process for calculating an access request period.

FIG. 4 is a flowchart showing an access control process.

FIG. 5 shows an example of waveforms of signals (data) sent and received by a memory controller of the embodiment of the invention.

FIG. 6 shows an example of waveforms of signals (data) sent and received by an ordinary memory controller.

### DESCRIPTION OF EXEMPLARY EMBODIMENTS

An embodiment of the invention will be described with reference to the drawings hereafter.

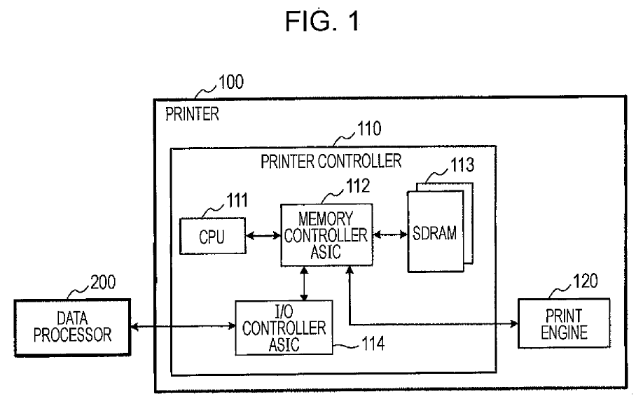

FIG. 1 shows an example of a hardware configuration of a printing system 10 to which the embodiment of the invention is applied. As shown in FIG. 1, the printing system 10 has a printer 100 and a data processor 200.

The data processor 200 is constituted by an ordinary computer having a CPU (central processing unit), a RAM (random access memory), a ROM (read only memory), a hard disk drive, a monitor such as a display, an input device formed by a keyboard, a mouse and so on, a communication interface configured to send and receive data to and from the printer 100 and so on which are not shown.

Various functions are implemented by the data processor 200 such as an application function for generating image data to be printed, a printer driver function for controlling the printer 100 and so on. The CPU is configured to run computer programs loaded from the ROM of the data processor 200 and so on to the RAM so that the various functions are implemented.

As shown in FIG. 1, the printer 100 has a printer controller 110 configured to control processing of the printer 100 and a print engine 120 configured to perform printing on a printing medium. The printer 100 may be a multifunction apparatus including an image reading device, a facsimile device and so on.

The printer controller 110 has a CPU 111, a memory controller ASIC 112, an SDRAM 113 and an I/O (input/output) controller ASIC 114. The printer controller 110 is configured to perform printing functions including various kinds of image processing (moiré processing, edge processing) and so on. The configuration of the printer 100 is not limited to the above, and, e.g., the CPU 111 may be contained in the memory controller ASIC 112. Moreover, the printer controller 110 is not limited to performing the printing function, and, e.g., may be configured to perform at least two of printing, facsimile, scanner and photocopier functions so that the printer 100 can work as a multifunction apparatus.

The CPU 111 is configured to access the SDRAM 113 through the memory controller ASIC 112, and read and write various data so as to perform various processes. The CPU 111 performs the various processes in designated processing units. The processing units in which the CPU 111 performs the processes are called “masters” hereafter. With respect to image processing, e.g., the processes such as moire processing, edge processing and so on are masters. The CPU 111 is configured to provide the memory controller ASIC 112 with an access request for accessing the SDRAM 113.

The memory controller ASIC 112 is configured to control the access from the CPU 111 to the SDRAM 113. The memory controller ASIC 112, however, may control direct access from the data processor 200 to the SDRAM 113 (not through the CPU 111).

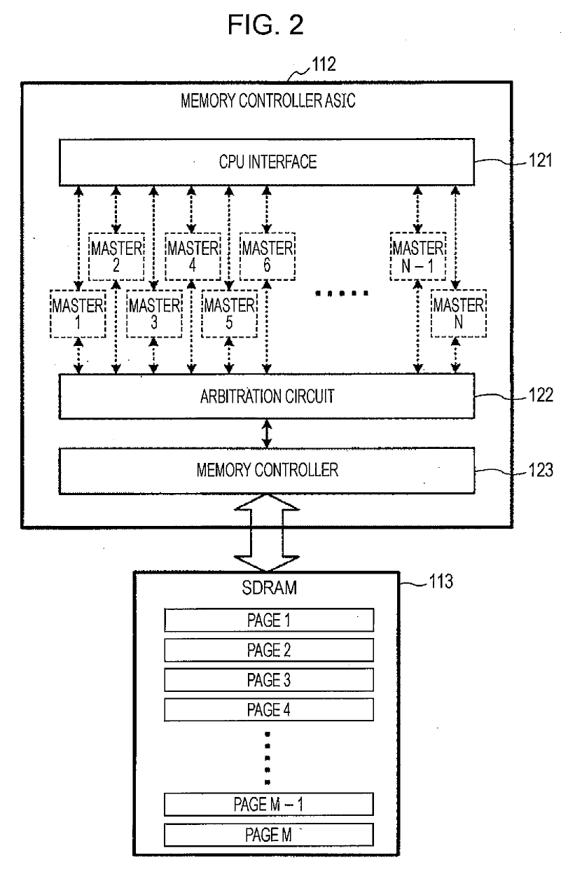

FIG. 2 shows an example of a hardware configuration of the memory controller ASIC 112. As shown in FIG. 2, the memory controller ASIC 112 has a CPU interface 121, an arbitration circuit 122 and a memory controller 123.

The CPU interface 121 is configured to accept an access request coming from the CPU 111 (an access request coming from the data processor 200 is included) and to notify the arbitration circuit 122 of the access request.

The arbitration circuit 122 is configured to accept the notified access request, and to notify the memory controller 123 of the access request. Upon accepting a plurality of access requests at a same time, the arbitration circuit 122 performs control for selecting one of the access requests and notifying the memory controller 123 of the selected access request.

Upon accepting the access request coming from the arbitration circuit 122, the memory controller 123 issues a designated command to the SD AM 113, and performs access control on the basis of the access request.

More specifically, every time the memory controller 123 accepts an access request, the memory controller 123 determines whether it is an access request for the same page (a page that is open at that time).

Upon determining that it is not an access request for the same page, the memory controller 123 issues to the SDRAM 113 an active command for opening the page requested to be accessed so as to perform a command process (to issue a read/write command). Meanwhile, upon determining that it is an access request for the same page, the memory controller 123 performs a command process without issuing an active command.

Then, regardless of whether it is an access request for the same page, the memory controller 123 issues to the SDRAM 113 a precharge command for closing the page that is open after a fixed period of time (called an open period hereafter) has passed since the access request was accepted.

Thus, upon accepting an access request for the same page before the open period has passed, the memory controller 123 can successively read and write data from and to the SDRAM 113 (issue a read write command) without issuing precharge and active commands. After the open period has passed, however, the memory controller 123 issues a precharge command so as to close the page. Thus, upon accepting an access request for the same page at a later time, the memory controller 123 needs to issue an active command again.

After issuing a precharge command, the memory controller 123 makes the open period variable so as to make an occurrence of accepting an access request for the same page (missing hitting the page) less probable.

More specifically, the memory controller 123 has a plurality of registers individually assigned to respective masters. Every time the memory controller 123 accepts an access request, the memory controller 123 calculates a period of an access request for the same page (called an access request period hereafter) for each of the masters and stores (updates) the access request period in each of the registers.

Then, upon accepting an access request, the memory controller 123 reads the access request period from the register corresponding to the master of the access request so as to set the access request period as the open period. The memory controller 123 can thereby set a variable open period in accordance with the access request period for each of the masters.

The memory controller 123 can calculate the access request period by using a method of, e.g., (1) using an accumulated mean value, (2) using a latest recorded value, and so on. Each of the methods will be described later in detail.

The SDRAM 113 is a memory controlled by the memory controller 123. As shown in FIG. 2, the SDRAM 113 has a plurality of (M) pages (storage areas) each of which is designated by a unique row address. The SDRAM 113 is accessed on a page-by-page basis. The SDRAM 113 is not limited to an SDRAM, and may be a memory, e.g., a DRAM having a page mode access function.

Referring back to FIG. 1, the I/O controller ASIC 114 controls data sent to and received from an external device (such as the data processor 200).

The print engine 120 has a paper feed mechanism and a print mechanism, and performs printing of data to be printed generated by the CPU 111.

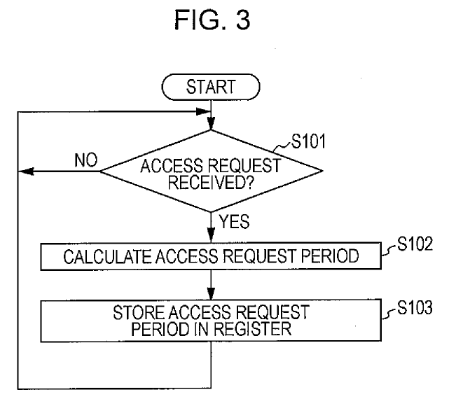

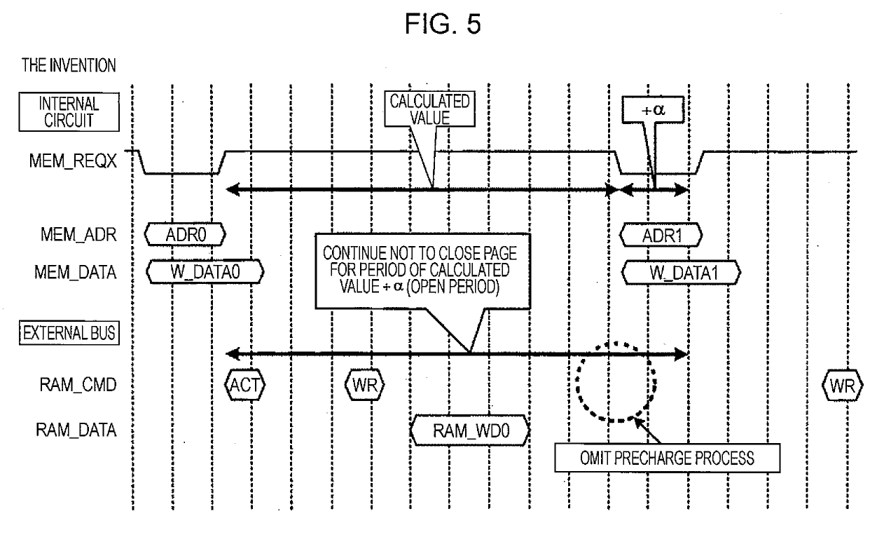

Then, an operation specific to the printer 100 of the printing system 10 configured as described above will be explained. FIG. 3 is a flowchart explaining a process in which the printer 100 calculates the access request period. Each of the above cases where the printer 100 calculates the access request period (1) by using an accumulated mean value and (2) by using a latest recorded value will be separately explained hereafter. FIG. 5 shows an example of waveforms of signals (data) sent and received by the memory controller 123 in the access control process.

### (1) Case of Using the Accumulated Mean Value

As shown in FIG. 3, upon the power supply to the printer 100 being turned on, the memory controller 123 starts a process for calculating the access request period.

Upon starting the process for calculating the access request period, the memory controller 123 waits to accept an access request coming from the CPU 111 through the arbitration circuit 122 and so on (step S101; No).

At this step, the memory controller 123 determines whether to accept an access request on the basis of a designated signal (MEM_REQX) provided from the arbitration circuit 122. As shown in FIG. 5, while accepting no access request, e.g., the memory controller 123 is provided with a MEM_REQX signal of a high (effective) value. Upon being provided with a MEM_REQX signal of a low (ineffective) value, the memory controller 123 determines to accept an access request. As shown in FIG. 5, the memory controller 123 accepts address data of the page requested to be accessed (MEM_ADR) and data to be written to the page (MEM_DATA) as well as the access request (MEM_REQX).

With reference back to FIG. 3, upon accepting the access request (step S101; Yes), the memory controller 123 calculates the access request period of the accepted access request (step S102).

More specifically, the memory controller 123 first obtains an accumulated mean value of the access request period from after the power supply was turned on and until the last time an access request is accepted (excluding the access request accepted at the step S101) (hereafter called the past accumulated mean value). The memory controller 123, e.g., identifies the master of the access request accepted at the step S101, and reads a value of the register corresponding to the identified master. As an initial setting, however, the register is loaded with a value of “0”.

Then, the memory controller 123 obtains the access request period after accepting the last access request and until accepting the access request of the same master again (this time) (hereafter called the latest period). Every time the memory controller 123 accepts an access request, e.g., the memory controller 123 starts counting by using a counter included in the memory controller 123. The memory controller 123 continues counting (increments of the counter value) until accepting an access request of the same master again. If the counter value exceeds a fixed maximum (100 clock pulses, e.g.,), however, the memory controller 123 stops counting and discards the counter value.

Then, the memory controller 123 calculates the accumulated mean value of the access request period from after the power supply was turned on and until the memory controller 123 accepts an access request this time. The memory controller 123 calculates, e.g., a mean value of the past-accumulated mean value (register value) obtained earlier and the latest period (counter value) obtained earlier (by dividing a sum of the register value and the counter value by two). This is represented by an equation Pn=(Pn−1+C)/2, where Pn, Pn−1 and C represent the latest accumulated mean value, the accumulated mean value calculated the last time (register value) and the latest period (counter value), respectively.

Then, the memory controller 123 stores (updates) the accumulated mean value calculated at the step S102 in the register corresponding to the master of the access request accepted at the step S101 (step S103). At this step, the value stored in the register becomes an open period of the page (in the SDRAM 113) that is accessed on the basis of the access request accepted at the step S101.

After storing the open period, the memory controller 123 resets the value (back to “0”), returns to the step S101, and calculates and stores an accumulated mean value for each of the masters every time the memory controller 123 accepts an access request coming from the CPU 111.

Thus, the memory controller 123 can calculate and record the access request period of each of the masters (the latest accumulated mean value) by using the past accumulated mean value. The calculated access request period corresponds to a period indicated by an arrow (calculated value) in FIG. 5.

The memory controller 123 calculates the accumulated mean value of the access request period from, although not limited to, the past accumulated mean value (register value) and the latest period (counter value). The memory controller 123, e.g., records how many times it accepts an access request for each of the masters. Then, the memory controller 123 divides the number of times by a period of time that has passed after the power supply was turned on (or after first accepting an access request) so as to calculate the accumulated mean value of each of the masters. This is represented by an equation Pn=CTotal/N, where Pn, CTotal and N represent the latest accumulated mean value, a total counter value and the number of times an access request has been accepted, respectively.

### (2) Case of Using the Latest Recorded Value

The memory controller 123 performs at the step S101 the same process as in the case (1) of using the accumulated mean value.

Moving on to the step S102, the memory controller 123 first obtains a period (latest period) from after accepting an access request the last time and until accepting the access request of the same master again (this time) (step S102), by using the same method as in the case (1) of using the accumulated mean value.

Then, the memory controller 123 stores (updates) the obtained latest period (counter value) in the register corresponding to the master of the access request accepted at the step S101 (step S103).

After storing the latest period, the memory controller 123 resets the counter value (back to “0”). Then, returning to the step S101, the memory controller 123 calculates the access request period of each of the masters for every access request coming from the CPU 111.

The memory controller 123 can thereby calculate and record the access request period of each of the masters by using the latest period (latest recorded value). The calculated access request period corresponds to a period indicated by an arrow (calculated value) in FIG. 5.

At the step S103, the memory controller 123 may store in the register a sum of the access request period calculated by using the above method (1) or (2) and a preset value (α) as a final access request period.

The memory controller 123 thereby stores in the register an access request period that is longer than the mean value of the actual access request period, so as to easily hit the page by using the value stored in the register as the open period of the page to be accessed. The preset value (α) corresponds to a period indicated by an arrow (+α) in FIG. 5. The final access request period corresponds to a period indicated by a lowest arrow (calculated value +α) in FIG. 5.

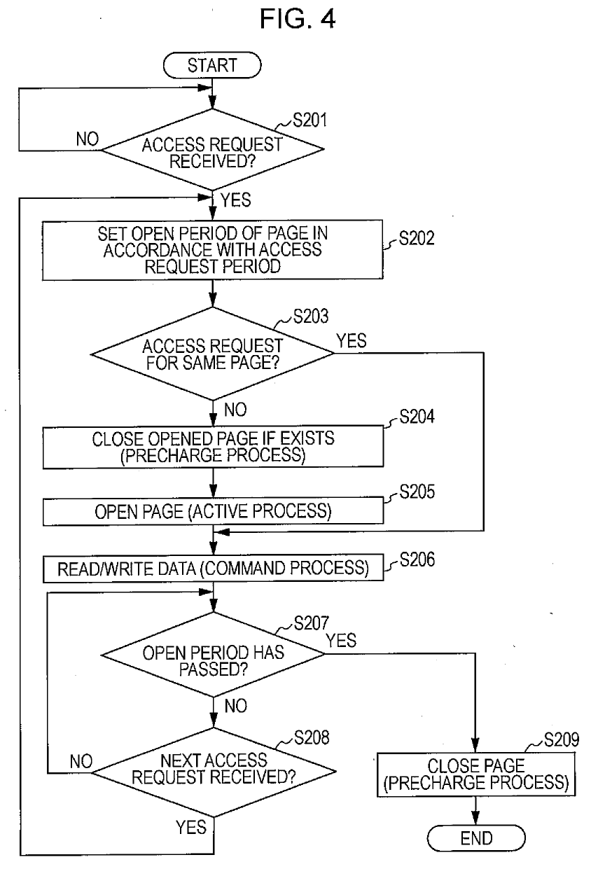

Then, another feature specific to the printer 100 will be described. FIG. 4 is a flowchart explaining an access control process performed by the printer 100.

Upon the power supply to the printer 100 being turned on, the memory controller 123 starts the access control process, as the process for calculating the access request period.

Upon starting the access control process, the memory controller 123 waits to accept an access request coming from the CPU 111 through the arbitration circuit 122 and so on (step S201; No).

Upon accepting an access request (step S201; Yes), the memory controller 123 sets an open period of a page (SDRAM 113) requested to be accessed at the step S201 (step S202). More specifically, the memory controller 123 first identifies a master of the access request accepted at the step S201, and reads a value in the register corresponding to the identified master so as to obtain an access request period. Then, the memory controller 123 sets the obtained access request period as the open period of the page (SDRAM 113) requested to be accessed.

Then, the memory controller 123 determines whether the page requested to be accessed at the step S201 is the same as the page open at the step S201 (having experienced no precharge process) (step S203). If there is no page open at the step S201, the memory controller 123 determines that the page requested to be accessed is not the same page.

Upon determining that the access request is not addressed to the same page (step S203; No), the memory controller 123 closes the page that is open (precharge process) (step S204). More specifically, the memory controller 123 issues a precharge command to the SDRAM 113. If there is no page open, the memory controller 123 omits the process of the step S203 and moves on to a step S205.

Then, the memory controller 123 opens the page requested to be accessed (MEM_ADR) at the step S201 (active process) (step S205). More specifically, the memory controller 123 issues an active command to the SDRAM 113. FIG. 5 shows an example of timing of issuing the active command (ACT).

After opening the page, the memory controller 123 reads and writes data from and to the page (command process) (step S206). More specifically, the memory controller 123 issues a read/write command to the SDRAM 113. In order to write data, e.g., after issuing the read/write command, the memory controller 123 writes data (MEM_DATA) accepted with the access request (MEM_REQX) to the page requested to be accessed (SDRAM 113) at the step S201 (RAM_DATA). In order to read data, after issuing the read/write command, the memory controller 123 reads data from the page requested to be accessed (SDRAM 113) at the step S201. FIG. 5 shows an example of timing of issuing the read/write command (WR).

Incidentally, upon determining that the access request at the step S203 is addressed to the same page (step S203; Yes), the memory controller 123 omits the precharge process (step S204) and the active process (step S205), and moves on to a step S206 so as to perform the command process (step S206). Upon hitting the page, the memory controller 123 can thereby efficiently read and write data from and to the SDRAM 113.

Moreover, after accepting the access request at the step S201, the memory controller 123 determines whether the open period set at the step S202 has passed (step S207). Every time the memory controller 123 accepts an access request at the step S201, e.g., the memory controller 123 starts to count by using a counter included in the memory controller 123 and so on. The memory controller 123 continues counting (increments of the counter value) until accepting a next access request as long as the counter value remains no greater than the length of the open period set at the step S202 (step S208; No).

Meanwhile, if the counter value exceeds the length of the open period set at the step S202 (step S207; No), the memory controller 123 closes the page that is open (precharge process) (step S209). More specifically, the memory controller 123 issues a precharge command to the SDRAM 113. Then, the memory controller 123 ends the access control process and returns to the step S201.

Moreover, upon accepting a next access request at the steps S207 and S208 while the counter value remains no greater than the length of the open period set at the step S202, the memory controller 123 returns to the step S202.

According to the access control process described above, as the memory controller 123 sets an open period of a page in accordance with a calculated access request period, the memory controller 123 can more probably hit the page.

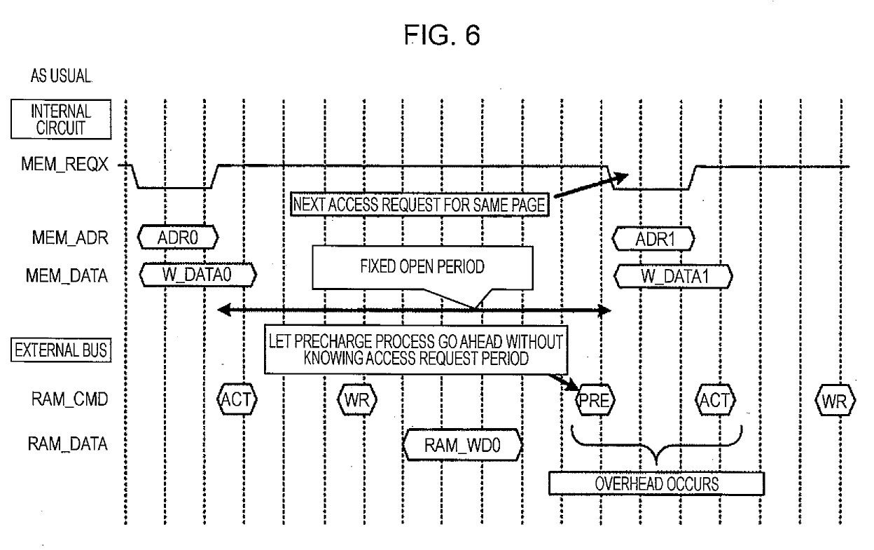

FIG. 6 shows an example of waveforms of signals (data) sent and received by the memory controller 123 in a case where, as usual, a fixed open period is used. In the usual case, as shown in FIG. 6, after the fixed open period (indicated by an arrow) has passed, the memory controller 123 issues a precharge command (PRE) so as to close the page. Thus, if the access request period for the same page is long, the memory controller 123 has to open the same page (issue an active command) again, resulting in an overhead being causing.

Meanwhile, as the memory controller 123 sets a variable open period as shown in FIG. 5, the memory controller 123 does not cause an overhead even in a case where the access request period for the same page is long (as indicated by a dotted circle).

The invention is not limited to the embodiment described above, and can be variously modified and applied.

According to the embodiment described above, e.g., the memory controller 123 calculates an access request period for each of the masters in the process for calculating the access request period. The invention is, however, not limited to the above. The memory controller 123 may, e.g., calculate a period at which one particular master requests to access one particular page. More specifically, the memory controller 123 has N (the number of the masters) times M (the number of the pages) registers. Every time the memory controller 123 accepts an access request, the memory controller 123 identifies the master of the access request and the page requested to be accessed, and calculates the access request period for each pair of the identified master and page. Then, the memory controller 123 stores (updates) the access request period in the register corresponding to the pair of the identified master and page. Moreover, at the step S202, the memory controller 123 identifies the master of the accepted access request and the page requested to be accessed, reads a value stored in the register corresponding to the pair of the identified master and page so as to set an open period. The memory controller 123 can thereby set an open period corresponding to the period at which the same page is requested to be accessed more properly than the embodiment described above.

The entire disclosure of Japanese Patent Application No. 2008-237533, filed Sep. 17, 2008 is expressly incorporated by reference herein.

What is claimed is:

1. A memory controller circuit configured to control an SDRAM, comprising:
a first unit configured to accept an access request provided by one of a plurality of masters for access to a page included in the SDRAM;
a second unit configured to record an access request period of each of the masters; and
a third unit configured to set an open period of the page on the basis of the access request period recorded in the second unit in accordance with the master having provided the access request, the third unit being configured to open the page requested to be accessed for the open period having been set.

2. An electronic apparatus controller device, comprising:
an SDRAM; and
a memory controller circuit configured to control the SDRAM, the memory controller circuit including
a first unit configured to accept an access request provided by one of a plurality of masters for a page included in the SDRAM,
a second unit configured to record an access request period of each of the masters, and
a third unit configured to set an open period of the page on the basis of the access request period recorded in the second unit in accordance with the master having provided the access request, the third unit being configured to open the page requested to be accessed for the open period having been set.

3. A multifunction apparatus having at least two of a printer function, a facsimile function, a scanner function and a photocopier function, the multifunction apparatus comprising:
the electronic apparatus controller device according to claim 2.

4. A memory controller circuit configured to control an SDRAM, comprising:
a first unit configured to accept an access request provided by one of a plurality of masters to one of a plurality of pages included in the SDRAM;
a second unit configured to record an access request period of each of the masters addressed to a corresponding one of the pages; and
a third unit configured to set an open period of the page on the basis of the access request period recorded in the second unit in accordance with the master having provided the access request and the page requested to be accessed, the third unit being configured to open the page requested to be accessed for the open period having been set.
